(19) United States
(12) Patent Application Publication
(10) Pub. No.: US 2005/0200923 A1
(43) Pub. Date: Sep. 15, 2005

(54) Image generation for editing and generating images by processing graphic data forming images

(76) Inventors: Kazumichi Shimada, Nagano-ken (JP); Akira Kasai, Kyoto-fu (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/063,373

(22) Filed: Feb. 22, 2005

(30) Foreign Application Priority Data
Feb. 25, 2004 (JP) 2004-50059

(51) Int. Cl. H04N 1/40

(52) U.S. Cl. 358/537; 358/448

(57) ABSTRACT

To make it easier and more convenient for users to edit images. The user marks certain locations in retouching instruction printed along with an original image which is to be edited so as to specify the desired edit process parameters by the marks. For example, edits can be made for better contrast, and the color tone and sharpness can be automatically adjusted. When the user wishes to edit an image in certain areas, burn parameters can be marked, and the user can specify those areas (burn areas) by directly drawing a frame on the printed image. The marked printing paper is read by a scanner, the edit process details indicated on the printing paper by the user are specified through analysis of the scanned results, and the original image is edited based on those details.

### BACKGROUND OF THE INVENTION

1. Description of the Related Art

The invention relates to a technique for editing and generating images by processing the graphic data from which images are composed.

Due to the recent popularity of digital still cameras and the like, images can be easily input with digital data. In view of the foregoing, techniques have been proposed for automatically adjusting contrast when such images are displayed, printed, or the like (such as Japanese Patent Laid-open Gazette No. 10-198802).

Such automatically adjusted images notwithstanding, the diverse preferences of users has resulted in the demand for the ability to further edit automatically adjusted images as desired. For such editing, the users themselves generally operate a mouse, keyboard, or the like to optimize images with image retouching software. However, as a certain degree of expertise is needed to retouch images, operate the mouse, and the like, users sometimes must give up the idea of editing images themselves.

### SUMMARY OF THE INVENTION

An object of the present invention is to solve the above problems and make it easier and more convenient for users to edit images.

To address at least part of the above object in the image-generating device of the invention, the graphic data composing the original image, which is a target image for editing and generating ,is retrieved by a first data retrieval unit, while a drawn image drawn on the surface of a print medium is scanned by a second data retrieval unit. Original image data specifying the original image and edit processing data specifying the edit process parameters indicating the data processing details for editing the original image are printed on the surface of the print medium. This data can thus be obtained from the draw image on the surface of paper media when the printed medium is scanned by the second data retrieval unit.

An image/edit specifying unit specifies the original image from original image data and specifies the edit process parameters from the edit processing data based on the original image data and edit processing data that have thus been obtained. An image-generating unit generates edited images by editing the original graphic data based on the specified edit process parameters, using as the original graphic data the graphic data already retrieved by the first data retrieval unit for the specified original image. The graphic data of the edited image that has been generated is output as the edited image data by an edited image output unit to a printing output unit, for example. Because the printing output unit prints the image based o the graphic data, the edited image is printed by the printing output unit based on the edited image data. The edited image data can be output to a printing output unit, as well as to a display device such as a projector, or to a memory device, or the like.

That is when the user prints the edited image, the original image data capable of specifying the original image and edit processing data for specifying edit process parameters indicating the data processing details for editing the original image are displayed as drawn images, and the print medium can be scanned by the second data retrieval unit. As a result, all the user has to do in order to edit the image is simply view the drawn image of the edit processing data and original image data on the surface of the print medium, and scan the print medium, with no need for complicated image retouching software or mouse operations, etc. The invention is thus far more convenient.

In the image-generating device of the invention, the print medium which is scanned by the second data retrieval unit comprises, as original image data, the original image printed by the printing output unit itself based on the original graphic data. As such, the original image which the user desires to edit and the edited image are printed by the very same printing output unit. The user can thus review the original image printed by the same printing output unit before editing the image, so that the editing specifications can be determined as the original image is viewed, without having to take into special consideration the printing properties of the printing output unit.

The original image thus serves as the original image data. The original image is used as graphic data when the second data retrieval unit scans the print medium. The image/edit specifying unit reads the graphic data from the second data retrieval unit and specifies the original image by comparing the graphic data with the graphic data retrieved by the first data retrieval unit. This affords the following advantages.

Because there are generally some differences in printing properties between printing output units, it is less likely that images printed on different printing output units will be the same when images are printed based on the graphic data from which the images are composed. In the case of brightness, for example, there will be various differences in the brightness of images printed by printing output units in which images are printed with higher brightness and printing output units in which images are printed with lower brightness, even when the images are printed based on the same graphic data. As such, unless these various differences in printing properties are taken into consideration when the second data retrieval unit is used to scan an original image printed by a different printing output unit from the printing output unit on which an edited image is printed, the process becomes more complicated for specifying the original image through a comparison of the graphic data scanned by the second data retrieval unit and the graphic data retrieved by the first data retrieval unit. However, since the image (original image) scanned by the second data retrieval unit will have been printed by the same printing output unit, it will be relatively simpler to specify the original image by comparison of the graphic data.

The following embodiment can be adopted. In this embodiment, the original image printed based on the original graphic data and identifying data such as a bar code corresponding to the printed original image are provided as original image data on the print medium scanned by the second data retrieval unit, allowing the original image retrieved by the first data retrieval unit to be specified by the image/editing specifying unit based on the identification data. Thus, even when the printing output unit printing the edited image and the printing output unit printing the original image are different, the original image can be specified by means of the identification data.

In this embodiment where the original image is thus printed on the print medium based on the original graphic data , when a diagram dividing the image editing areas is drawn for the printed original image on the print medium, the image/edit specifying unit specifies the editing divisions based on the data for the diagram read from the second data retrieval unit, and the image-generating unit processes the original graphic data for the image in the specified edition divisions to generate an edited image for the editing divisions of the original image. The edited image output unit then outputs the edited image data for the edited image and the original graphic data for the original image other than in the edit divisions to the printing output unit. Thus, the simple operation of drawing a diagram for the printed original image on the print medium allows the edited image, in which only the edit divisions divided by the diagram have been edited, to be output and printed. When a mouse is used to draw the drawing on a screen, some effort will be required if a user with little experience in the use of a mouse cannot draw a diagram as desired, but the above embodiment is more convenient because the diagram can be drawn right on the print medium.

The present invention can also be implemented in embodiments comprising a printing output unit along with the first and second data retrieval units.

In another embodiment of the invention for overcoming at least some of the problems described above, the original image viewed by the user is an original image displayed on a display device based on the graphic data retrieved by the first data retrieval unit instead of a printed original image on the surface of print medium, and the data retrieved by the second data retrieval unit is used as the edit processing data printed on the surface of the printed medium. The image-generating device having this structure is also far more convenient to use, as all the user has to do in order to edit the image is simply view the drawn image of the edit processing data on the surface of the print medium, and scan the print medium.

The print medium used in the image-generating device described above can comprise print embodiments allowing the user to select data processing details for at least the brightness, color tone, or sharpness of the image. This will be even more convenient to use because the user can easily select the edit process parameters.

In this case, the status of the edited image obtained by data processing using these data process details can be printed for the user to view. This is even more convenient for the user because the user can see how the image obtained from the edited results will look on the print medium before editing the image.

The generation of edited images in the present invention as described above can be done in a variety of embodiments such as image-generating methods, of course, as well as in the form of embodiments such as computer programs for allowing a computer to run the image-generating device or the functions of the method, and recording media and the like on which such programs are recorded.

### BRIEF DESCRIPTION OF THE DRAWINGS

FIG. 1 illustrates an image-generating system 100 as a first example of the invention.

FIG. 2 is a flow chart of the procedures of the image-generating process in the first. example for generating an edited image by editing an image retrieved by an original graphic data input unit 41 as commanded by a user.

FIG. 3 illustrates an example of printing paper used to show the editing details by a user upon performing the image process in the first example.

FIG. 4 illustrates how the user indicates the editing details on the printing paper in FIG. 3 upon performing the image process in the first example.

FIG. 5 illustrates a printed image obtained by using the user's editing details indicated on the printing paper in FIG. 4.

FIG. 6 is a flow chart of the procedures for the image editing process in a second example.

FIG. 7 illustrates an example of printing paper used to show the editing details by a user upon performing the image process in the second example.

FIG. 8 illustrates a variant of printing paper that is scanned when specifying the edited original image or the editing process details.

FIG. 9 illustrates another embodiment of retouching instructions for indicating the editing process details (retouching instructions).

FIG. 10 illustrates another embodiment of retouching instructions.

### DESCRIPTION OF THE PREFERRED EMBODIMENTS

Embodiments of the invention are described in examples in the following order.

A. Example 1

A1. Structure of Image -Generating Device

A2. Image Process

B. Image Process in Example 2

C. Variants

### A. EXAMPLE 1

A1. Structure of Image-Generating Device

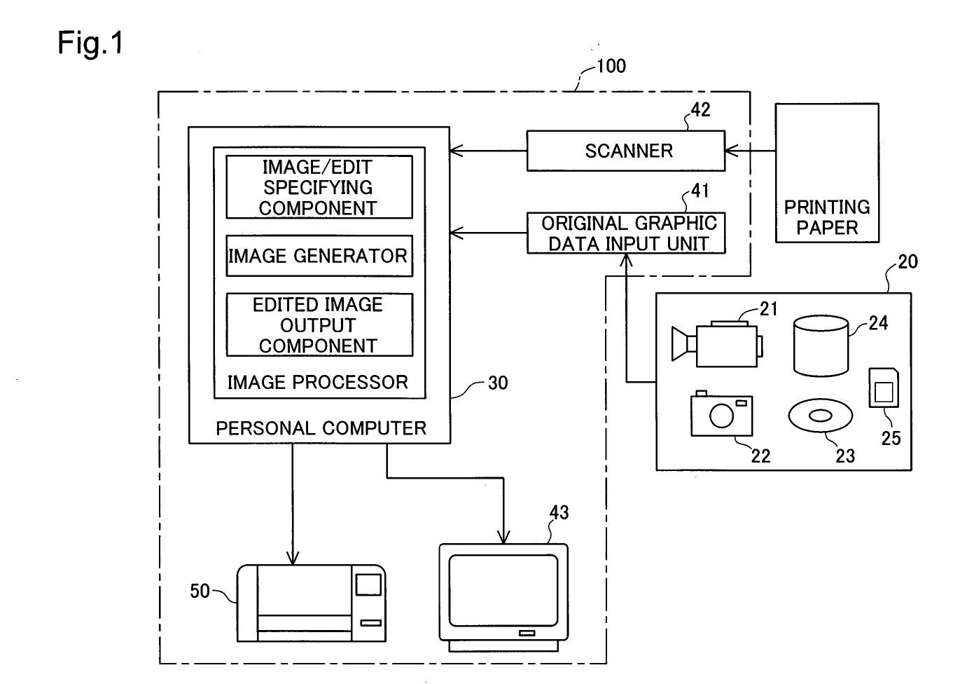

FIG. 1 illustrates an image-generating system 100 as a first example of the invention. As illustrated, the image processing system 100 comprises a personal computer 30 as a primary instrument, and is composed as what is referred to as a composite system having an original graphic data input unit 41 or scanner 42, display 43, and color printer 50. The original graphic data input unit 41 allows the input of graphic data from a graphic database to which graphic data such as motion pictures or still pictures are supplied, and outputs the data to the personal computer 30. The personal computer 30 stores the input graphic data in memory (not shown) or a memory device such as a hard disk.

The scanner 42 scans images/diagrams or the like drawn on the surface of print medium such as printing paper and converts them to graphic data which is output to the personal computer 30. The color printer 50 prints images (edited images) obtained after image processing by the personal computer 30, or images based on graphic data input from the original graphic data input unit 41, onto print medium.

The graphic data base 20 has a device for handling images such as a digital video camera 21, digital still camera 22, DVD 23, hard disc 24, or memory card 25, and supplied the graphic data to the personal computer 30. The graphic data kept in the graphic data base in the first example is still image data obtained by a digital still camera 22 or still image data stored on a memory card 25.

The personal computer 30 is arranged so that the image editing described below is output to the color printer 50 or display 43.

The personal computer 30 comprises devices such as a CPU, ROM, RAM (not shown), and hard disk on which image processing software is installed, and uses these parts to execute the various functions of the image processor which has an image/edit specifying unit, image-generating unit, and edited image output unit. The personal computer 30 also exchanges data with external devices such as the original graphic data input unit 41, scanner 42, display 43, and color printer 50 through an I/F circuit (not shown). The image process of the software installed on the hard disk generates edited images by editing images retrieved by the original graphic data input unit 41 as commanded by the user. The course of the image process is described in detail below.

A2. Image Process

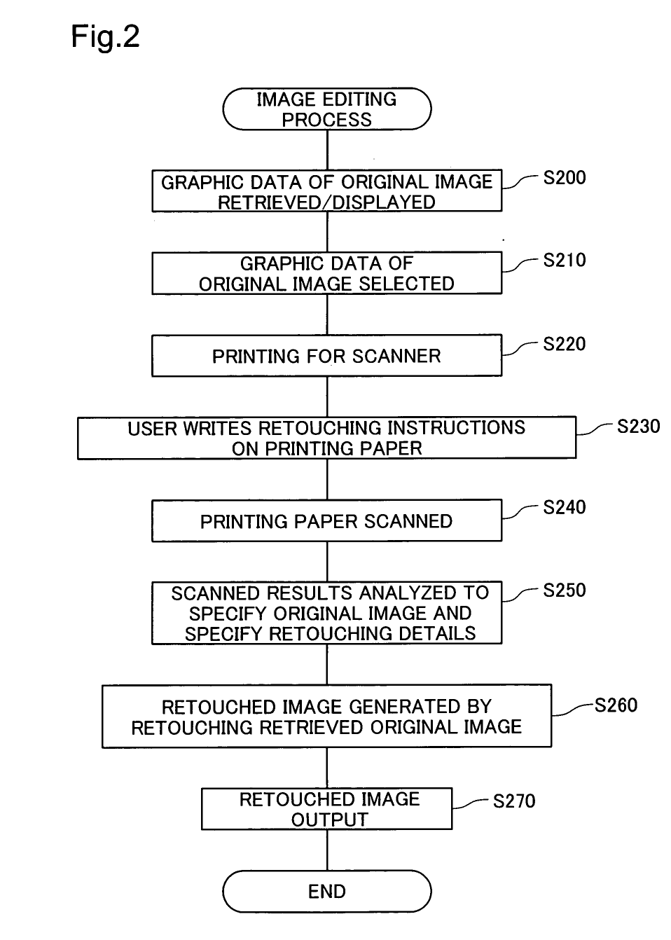

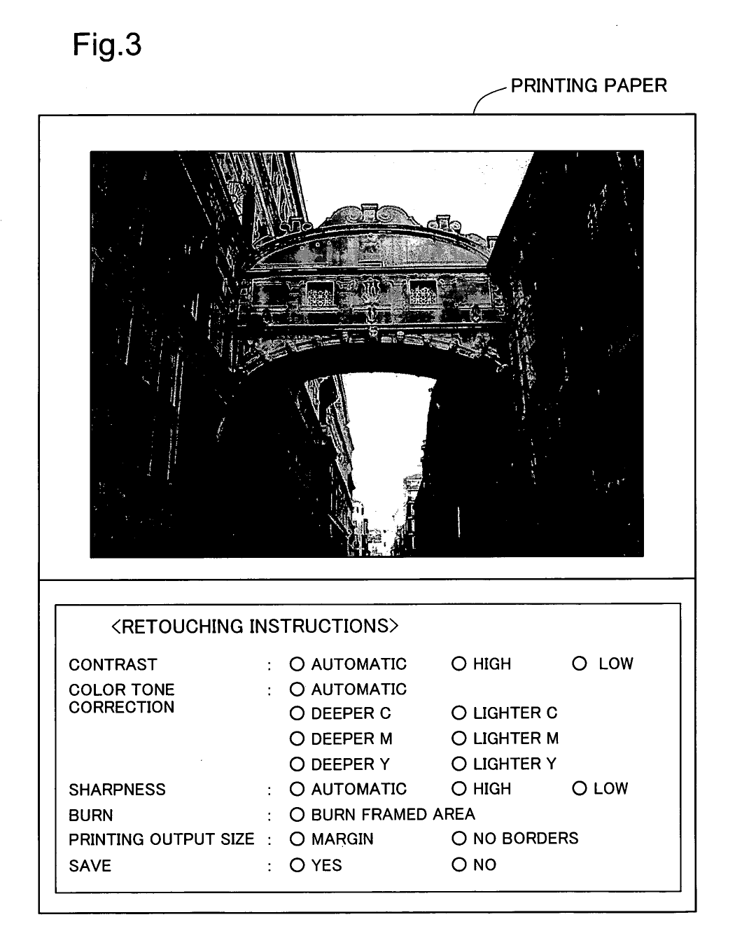

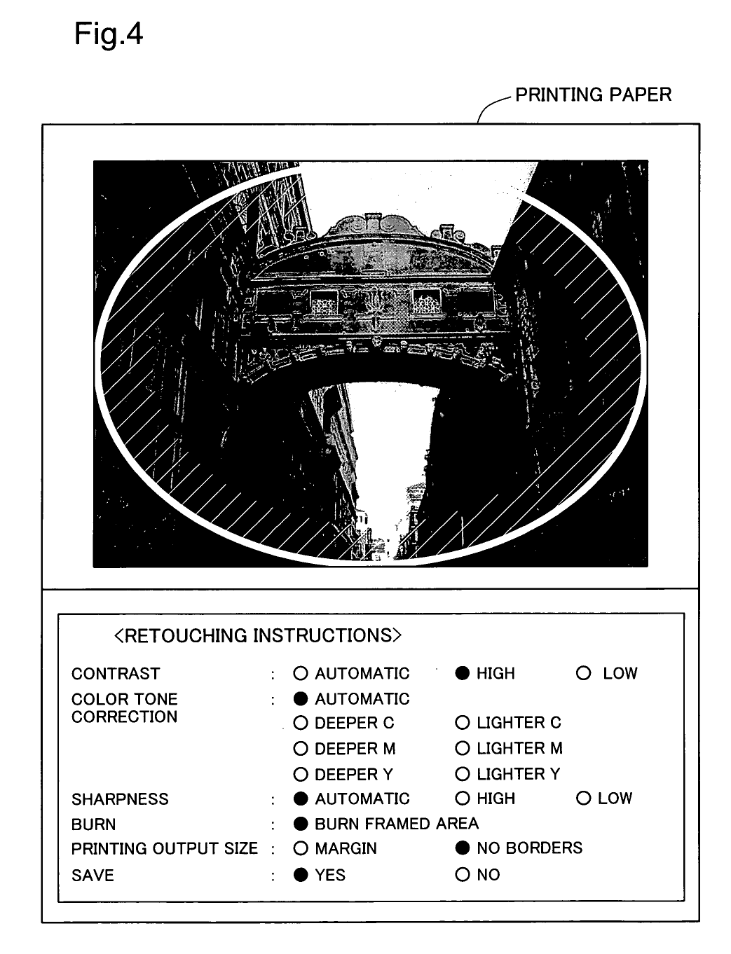

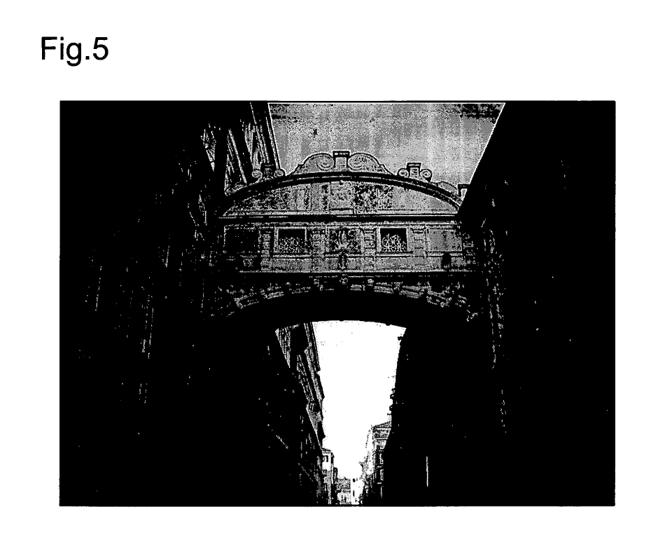

FIG. 2 is a flow chart of the procedures of the image-generating process in the first example for generating an edited image by editing an image retrieved by the original graphic data input unit 41 as commanded by a user. FIG. 3 illustrates an example of printing paper used to show the editing details by a user upon performing the image process in the first example. FIG. 4 illustrates how the user indicates the editing details on the printing paper in FIG. 2 upon performing the image process in the first example. FIG. 5 illustrates a printed image obtained by using the user's editing details indicated on the printing paper in FIG. 4.

The image editing process indicated in FIG. 2 is started by any user operation, such as the operation of a key such as a keyboard or a switch (not shown), in the image processing system 100 having the hardware noted above. The process can also be started by using the mouse to click an icon for starting the image edit which is displayed on the display 43.

When the image editing process is started, the personal computer 30 retrieves the graphic data of original images stored on the memory card 25 of a graphic data base, for example, that is, the original image which is to be edited, by means of the original graphic data input unit 41, and displays the original image on the display 43 based on the graphic data of the original image (this data is referred to below as the original graphic data) (Step S200). To display images, thumbnails can be used to allow the images to be seen at a glance in the display area on the right half of the display 43, or the images can be switched one at a time in sequence. The user selects the desired image by operating the keyboard, mouse, or the like, allowing the personal computer 30 to queue the original images (Step S210). If one original image is targeted for data retrieval in Step S200, the original image selected in Step S210 can be displayed instantly on the display 43, making the selection queuing unnecessary.

The personal computer 30 outputs the original graphic data for the pixels forming the selected original image (such as dot matrix pixels) and data on user-selectable edit process parameters to the color printer 50, where the data is printed in order to be scanned by the scanner 42 (Step S220). The printed results are illustrated in FIG. 3. The original image is printed at the top of the printing paper based on the original graphic data, and the retouching instructions are in the area below the image. The retouching instructions include various parameters, such as the contrast, which determines the details for adjusting the brightness of the image, color tone correction, which determines the appearance of color tones in the image, sharpness, which determines the image sharpness, burning, which determines that the image editing areas are limited to certain areas, and printing output size, which determines the printing output size on the printing paper.

As illustrated, the edit process parameters are set up to allow the user to mark them in making a selection. The user makes one mark per parameter. In this example, one mark can be selected from automatic, high, or low for image contrast, such as brightness or density. Other than the automatic setting, the level of any color component (cyan (C) level, magenta (M) level, yellow (Y) level) may be selected for color tone correction, such as tint, hue, or saturation. The markings for sharpness are automatic, high, and low. The default settings are to edit the entire image, without burning, and burning should therefore be marked only when the user wishes to limit the image edit areas to certain areas. The print output size can be marked to print the edited image on paper with a margin around the image (margin) or without a margin (no border). When the color printer 50 is unable to handle printing without borders, a printing parameter such as shrink/magnify can be marked. Edit parameters such as white balance can also be added.

Various adjustment methods can be adopted in which the contrast is automatically adjusted, the color tone is automatically corrected, or the sharpness is automatically adjusted based on the nature of the image, such as whether it is a landscape or portrait. The optimal adjustment of sharpness, in particular, will vary according to the output size when the image is printed, and can therefore be automatically adjusted depending on output size. A smoothing process for eliminating noise with preference for bringing out flesh tones (cosmetics) can also be added to the edit detail parameters for portrait images.

In the present example, the retouching directions can include a parameter on whether or not to store the graphic data of the edited image on the hard disk of the personal computer 30, the memory card 25 in an image data base 20, or the like. The user can provide commands on how to store the data in the same manner as for making the above edit process parameters.

The user writes the retouching commands needed to specify the desired editing details on the printing paper resulting from the above scan printing (Step S230). The results are illustrated in FIG. 4. FIG. 4 illustrates an example in which the user marks high contrast, marks automatic color tone correction and sharpness. marks burning limited to specific areas of the image edit areas, and marks borderless printing for the print output size. The user draws a frame in a desired shape on the printed original image in the areas that are to be burned (burn areas), thus indicating the area inside the frame. In the illustrated example, a patch is applied inside the frame to indicate that the interior of the frame is the burn area. Patches are applied outside the frame when the area outside the frame is to be burned. This arrangement can be established in various ways. For example, the burn areas can be completely painted out so specify the burn areas on the printed image. The user specifies the desired editing details by means of a frame drawing or marks written in the retouching directions on the printing paper.

The user employing the marks or diagrams sets the printing paper up in the scanner 42 to allow the marked/diagrammed printing paper to be scanned by the scanner 42 (Step S240). The scanner 42 converts the scanned original image printed on the printing paper, the drawn diagram, and the marks in the retouching instructions to graphic data, and outputs the data to the personal computer 30.

The personal computer 30 receives the graphic data scanned by the scanner 42, and analyzes it, that is, specifies the original image which the user wishes to edit, and specifies the edit process details (retouching details) (Step S250). In the present example, when the original image selection in Step S210 and the scanning of the printed paper (Step S220) on which the image has been printed are continuously processed, the original image is specified as the selected original image.

On the other hand, multiple original images, for example, may be selected for editing in Step S210, each of the multiple selected original images may be individually printed on printing paper in Step S220 as illustrated in FIG. 3, and one of the sheets of stacked printed paper may be scanned in Step S230 (Step S240). In this case, analysis of the scanned results in Step S250 involves comparing the graphic data for the image obtained by the printing paper scan to the graphic data of the multiple original images (original graphic data) selected for editing in Step S210, and specifying the original image which the user wishes to edit from the plurality of original images that are to be edited. In this case, if a frame is drawn to indicate burn areas, the original image which the user wishes to edit can be specified from the plurality of original images targeted for editing by comparing the graphic data for the image areas except for the parts in the frame.

In general, the graphic data obtained by means of the scanning operation with the scanner 42 will not be completely consistent with the graphic data of the printed image (the original image, in this case). However, this should not be a serious problem, since a data process such as one that reflects the scanning properties of the scanner 42 in the graphic data of the scanned results can be used to determine whether or not the graphic data of the printed image is consistent with the graphic data of the scanned results for the same image. When the original image/retouching instructions in FIG. 3 are printed on a printer that is different from the color printer of the image processing system 100, the image (original image) can be specified by taking into consideration the printing properties of the printer (such as the brightness properties of printed images).

The edit process details are specified in the following manner. The personal computer 30 analyzes the marked status of the retouching instructions based on the graphic data obtained from the scanner 42, and specifies the edit process details desired by the user. In the example illustrated in FIG. 4, the personal computer 30 specifies that the edit process details desired by the user are to print the image with high contrast as well as automatically adjusted color tone correction and sharpness, with burning and without borders. Since this example includes burning, the personal computer 30 matches the graphic data for portions of the original image in the form of the scanned results of the scanner 42 with the graphic data for the specified original image (original graphic data) to specify the burn areas. That is, because the frame drawn on the printed image is included in the graphic data of the graphic data of the scanned results, the burn areas can be specified by matching the above data.

When the analysis of the scanned results is complete, the personal computer 30 excutes the specified edit process details (retouching details) which include the data processes for high contrast adjustment as well as for automatic adjustment of the color tone correction and sharpness in FIG. 4 for the original graphic data of the image included in the specified burn areas, and generates an edited image (retouched image) (Step S260). In this case, the edited image that is ultimately generated is one in which the original image in the areas of the image other than the burned areas is matched with the image resulting from the data process on the burn areas (edited image). When burning is not set, the edit process details are processed on the entire original image, as noted above.

The graphic data of the edited image thus generated (retouched image) is output to the color printer 50 (Step S270), and the color printer 50 prints out the edited image based on the graphic data. FIG. 5 illustrates an example of the print out. The printed image is obtained as a result of the user running a data process on the edit process details (retouching details) indicated by the user on areas (burn areas) indicated by the means of a frame which the user wished to edit, as illustrated in FIG. 4, allowing the original image to be edited in this manner.

When the data is output to the color printer 50, the graphic data of the edited image which has been generated is output to the display 43, allowing the edited image to be checked on the screen. When the edited image in FIG. 5 is printed, the edit process parameters which the user has marked in the retouching direction can be printed at the bottom of the printing paper or in headers/footers. This will be useful for future editing guidelines as the user can view the edit process parameters leading to the edited image, along with the edited image.

To edit the original image with the editing process details desired by the user in the example for implementing this series of image editing processes, the user merely selects marks specifying the desired edit processing details in the area of the retouching directions on the printing paper illustrated in FIG. 4, writes on the printing paper in the burn areas desired by the user if necessary, and scans the printing paper on the scanner 42. No expertise in the use of a mouse is thus needed, making it much easier for the user to edit images.

In this example, when the user desires to limit the edits to certain areas in the image (burn areas), the burn areas can be specified by a line drawn by the user directly on the original printed image on the printing paper. Thus, just by the simple act of drawing a frame on the printed original image on the printing paper, it is possible to print out an edited image in which only the burn areas have been edited as illustrated in FIG. 5. Since. it is not always possible for a user with little experience in the use of a mouse to draw a frame as envisioned when using a mouse to draw the frame on the original image displayed on the display 43, considerable effort may be required, whereas in the present example, the frame can be drawn on the printing paper, which is more convenient.

In this example, the original image printed by the printer 50 itself based on the original graphic data of the original image retrieved through the original graphic data input unit 41 is printed on printing paper scanned by the scanner 42. The original image which the user wishes to edit (printed image in FIG. 3) and the edited image (printed image after being edited in FIG. 5) are thus the image printed by the same color printer 50. Since the user can thus view the original image printed by the same color printer 50 on the printing paper before it is edited, the editing specifications can be determined by looking at the original image printed on the printing paper, without having to take into consideration the printing properties of the color printer 50. The user can thus readily specify the edit process details by marking them.

### B. Image Process in Example 2

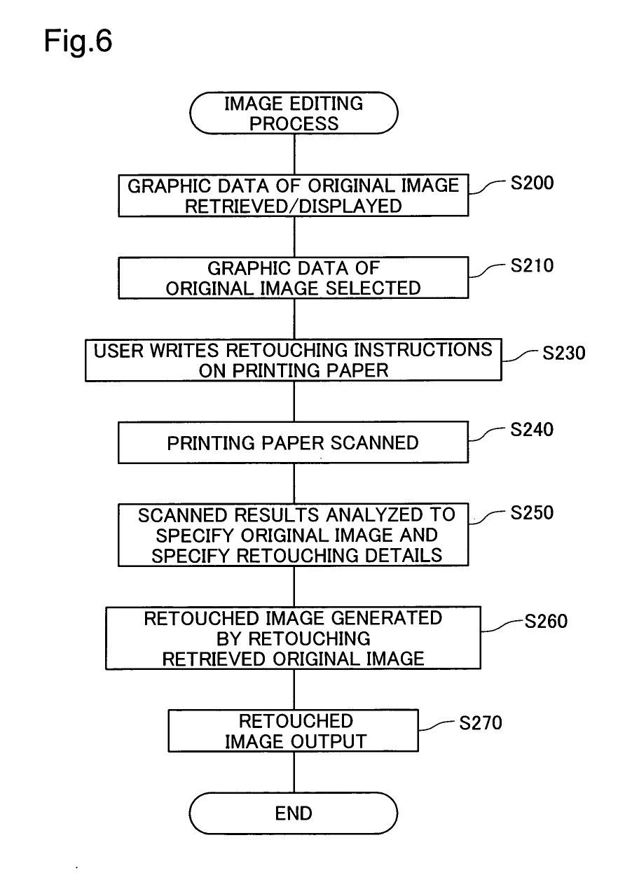

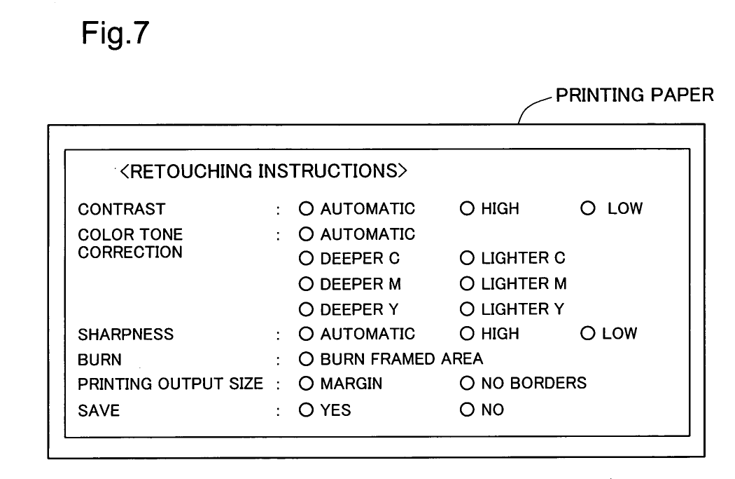

In the second example, the hardware is the same as in Example 1 described above and some of the details of the image editing process are the same. FIG. 6 is a flow chart of the procedures for the image editing process in the second example. FIG. 7 illustrates an example of printing paper used to show the editing details by a user upon performing the image process in the second example.

The difference in the image editing process procedure in the second example illustrated in FIG. 6 is that the user specifies only the edit process details (retouching directions) without printing the original image for scanning (Step S220).

That is the original images which are candidates for editing by the user are retrieved and displayed by the original graphic data input unit 41 from a memory card 25 or the like (Step S200), the user selects the desired original image (Step S210), the user marks the edit process parameters in the retouching directions illustrated in FIG. 7 (Step S230), and marked printed paper is scanned (Step S240). In other words, in this example, the original image selected in Step S210 is the image which the user wishes to edit, and the original image is thus only displayed on the display 43. The original image is not printed.

The analysis of the scanned results on the printing paper in Step S250 involves specifying the edit processing details with marks, and the edit process details are processed in Steps S260 and after to generate an edited image by processing the original graphic data for the original image. In this example, because burn areas are not determined by drawing a frame on the printed image, burning can be omitted.

In this example as well, to edit the original image with the editing process details desired by the user, the user merely selects marks specifying the desired edit processing details in the area of the retouching directions on the printing paper illustrated in FIG. 7 and scans it. No expertise in the use of a mouse is thus needed, making it much easier for the user to edit images.

### C. Variants

A few examples were described above, but the invention is not limited to these examples or embodiments and can be implemented in a variety of embodiments without departing from the spirit of the invention. The following variants are possible, for example.

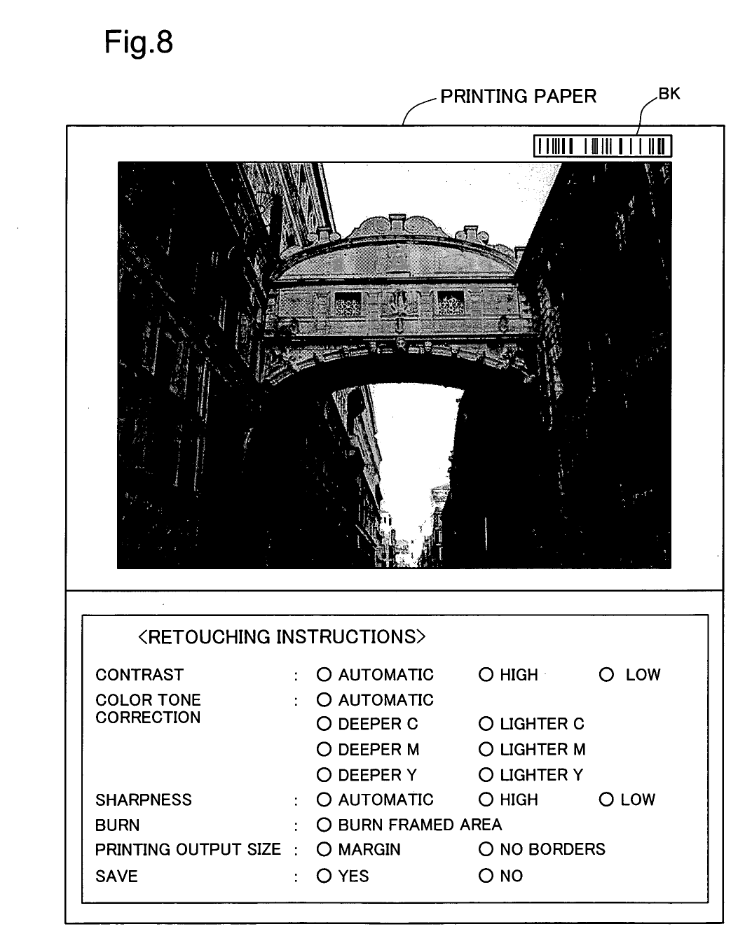

FIG. 8 illustrates a variant of printing paper that is scanned when specifying the edited original image or the editing process details. In addition to the retouching instructions and original image which the user wishes to edit, the printing paper in this variant also includes, as illustrated in the figure, a bar code BK specifying the original image that is printed, that is, the original image that is to he edited. When the printing paper is scanned by the scanner 42 after being marked and having a frame drawn on it as described above, the original image can be readily specified by scanning the bar code BK. Thus, even when the printer which prints the original image that is to be edited is different from the color printer 50 of the image processing system 100, the original image can be easily specified without taking the printing properties of the printer into consideration, making this a more practical alternative. In this case, when images stored on a memory card 25 or the like are retrieved from the original graphic data input unit 41, they should be retrieved by ensuring that the data of the bar code BK corresponds to the graphic data of the original image. The original images can also be specified with other forms of code data, not just bar code BK.

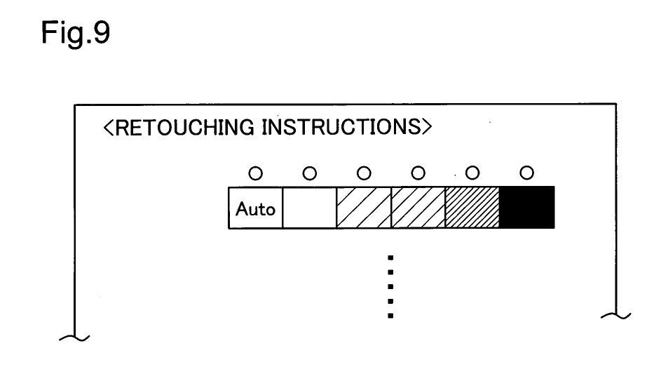

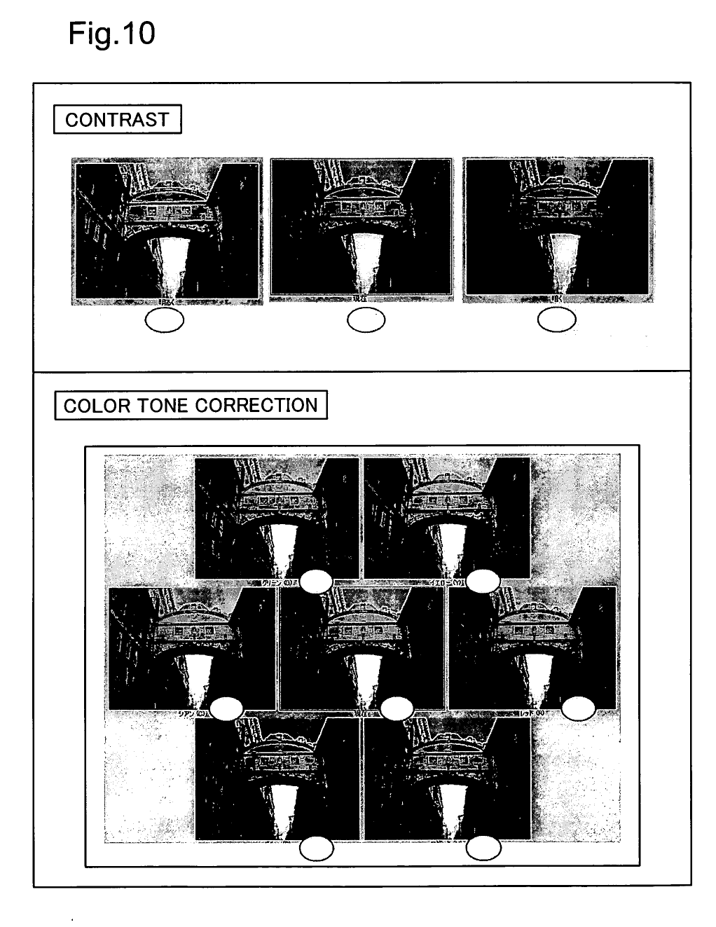

FIG. 9 illustrates another embodiment of retouching instructions for indicating the editing process details (retouching instructions), and FIG. 10 illustrates another embodiment of retouching instructions.

The retouching instructions illustrated in FIG. 9 allow the contrast, color tone correction, and the like which were marked in the previous examples to be selected and indicated at other levels, so that the user can make more refined edits on the desired image. For example, when the retouching directions that are illustrated are for color tone correction (cyan correction), either automatic correction or up to 5 levels of cyan correction can be selected by being marked. Not only does this make it easier for the user to select edit process parameters, but the user can select more detailed image editing.

The retouching instructions in FIG. 10 allow images to be printed so that the user can view the edited image after the contrast and color tone correction have been modified, so that the user can select (mark) the edit process parameters while actually viewing the edited image. In other words, the existing image is shrunk and printed based on the graphic data of the original image, and shrunk images in which the image has been edited with brighter contrast and shrunk images in which the image has been edited with darker contrast are printed side by side to the left and right. The user then selects the mark for existing, brighter, or darker contrast.

For color tone correction, the existing image is shrunk and printed based on the graphic data of the original image, and shrunk images in which the image has been edited with deeper yellow, deeper green, deeper cyan, deeper blue, deeper magenta, and deeper red are printed side by side counter clockwise from the upper right. The user then selects the mark for the existing color tone or any of the above color adjustments. This is even more convenient to use because the user can view how the edited image will look on printing paper before being edited.

A composite system with a color printer 50 was used in the above example, but the invention is not limited to this. Various other embodiments can be used, such as arrangements in the form of personal computers 30 without a color printer 50, or arrangements in which a scanner 42 or color printer or connected to a network.

1. An image-generating device for editing and generating images by processing the graphic data from which the images are composed, the image-generating device comprising:
a first data retrieval unit that retrieves graphic data composing an original image which is a target image for editing and generating;
a second data retrieval unit that scans a print medium to retrieve data related to the drawn image, the second data retrieval unit scans the print medium on the surface of which have been printed original image data capable of specifying the original image and edit processing data for specifying edit process parameters indicating data-processing details for editing the original image;
an image/edit specifying unit that specifies the original image from the original image data and specifies the edit process parameters from the edit processing data, the image/edit specifying unit retrieves the original image data and the edit processing data from scanned results when the second data retrieval unit scans the print medium on the surface of which have been printed the original image data and the edit processing data,
an image-generating unit that generates edited images from the original graphic data, which is the graphic data retrieved by the first data retrieval unit for the specified original image, based on the specified edit process parameters; and
an edited image output unit that outputs the edited image data, which is the graphic data of the edited image.

2. An image-generating device according to claim 1, wherein the edited image output unit outputs the edited image data to a printing output unit for printing the image based on the graphic data.

3. An image-generating device according to claim 2, wherein the print medium scanned by the second data retrieval unit comprises, as the original image data. the original image printed by the printing output unit based on the original graphic data, and
the image/edit specifying unit specifies the original image by reading, as the graphic data, the original image printed on the print medium from the second data retrieval unit and comparing the read graphic data to the graphic data retrieved by the first data retrieval unit.

4. An image-generating device according to claim 2, wherein the print medium scanned by the second data retrieval unit comprises the original image which has been printed based on the original graphic data, and identification data, such as a bar code corresponding to the printed image, which has been printed as the original image data, and
the image/edit specifying unit specifies the original image retrieved by the first data retrieval unit based on the identification data.

5. An image-generating device according to claim 4, wherein the image/edit specifying unit specifies edit divisions based on data for a diagram retrieved from the second data retrieval unit, when the diagram for dividing the image edit areas of the original image printed on the print medium is drawn on the print medium,
the image-generating unit processes the original graphic data for the image in the specified edit divisions to generate an edited image for those edit divisions in the original image, and
the edited image output unit outputs the edited image data for the edited image and the original graphic data for the parts of the original image other than the edited divisions to the printing output unit.

6. An image-generating device according to claims 5, comprising the printing output unit.

7. An image-generating device for editing and generating images by processing the graphic data from which the images are composed, comprising:
a first data retrieval unit that retrieves graphic data composing an original image which is a target image for editing and generating;
a display unit that displays the original image based on the original data which is the graphic data retrieved by the first data retrieval unit for the original image;
a second data retrieval unit that scans a print medium to retrieve data related to the drawn image, the second data retrieval unit scans the print medium on the surface of which have been printed edit processing data for specifying edit process parameters indicating data-processing details for editing the original image;
an edit specifying unit that specifies the edit process parameters from edit processing data, the edit specifying unit retrieves the edit processing data from scanned results when the second data retrieval unit scans the print medium on the surface of which have been printed the edit processing data;
an image-generating unit that processes the original graphic data retrieved by the first data retrieval unit and generates edited images based on the specified edit process parameters; and
an edited image output unit that outputs the edited image data, which is the graphic data of the edited image, to the display unit and a printing output unit for printing images based on the graphic data.

8. An image-generating device according to claims 1 or 7, wherein the print medium comprises a printing mode allowing the user to select data processing details for at least the brightness, color tone, or sharpness of the image.

9. An image-generating device according to claim 8, wherein the print medium is printed in such a way that the status of the edited image obtained by data processing based on the data processing details is visible to the user.

10. An image-generating method for editing and generating images by processing the graphics data from which images are composed, comprising the steps of:
(a) retrieving graphics data for an original image which is a target image for editing and generating;
(b) scanning a print medium on the surface of which have been printed the original image data capable of specifying the original image and edit processing data for specifying edit process parameters indicating data-processing details for editing the original image;
(c) specifying the original image from the original image data and specifying the edit process parameters from the edit processing data based on the scanned results;
(d) processing the original graphic data, which is the graphic data retrieved in step (a) for the specified original image, and generating an edited image based on the specified edit process parameters; and
(e) outputting the edited image data, which is the graphic data of the edited image, to a printing output unit for printing images based on the graphic data.
